(19) United States
(12) Patent Application Publication
(10) Pub. No.: US 2005/0125451 A1
(43) Pub. Date: Jun. 9, 2005

(54) SEARCH ENGINE AND DOMAIN NAME SEARCH INTEGRATION

(75) Inventor: Lucas Mooney, Scottsdale, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 10/906,250

(22) Filed: Feb. 10, 2005

(51) Int. Cl. G06F 17/30; G06F 7/00

(52) U.S. Cl. 707/104.1; 707/10

(57) ABSTRACT

Systems and methods of the present invention allow for providing a user with domain name suggestions in response to a search performed on a computer network. For example, when the user performs a search using a search engine, the search engine may forward a search query provided by the user to a domain name module. The domain name module may generate domain names based on the search query. The search engine, then, may return search results and the domain names to the user. The invention may be used as a marketing technique for sale or resale of the domain names.

### FIELD OF THE INVENTION

The present invention relates to systems and methods for searching information on computer networks and systems and methods for registering domain names.

### BACKGROUND OF THE INVENTION

The Internet is a worldwide network of computers and computer networks arranged to allow the easy and robust exchange of information between users of computers. Hundreds of millions of people around the world have access to computers connected to the Internet via Internet Service Providers (ISPs). Content providers place multimedia information, i.e. text, graphics, sounds, and other forms of data, at specific locations on the Internet referred to as websites. The combination of all the websites and their corresponding webpages on the Internet is generally known as the World Wide Web (WWW) or simply web.

Websites may be created using HyperText Markup Language (HTML). The HTML tags define how the webpages for the website are to be displayed. Users of the Internet may access content providers' websites using software known as a Web browser, such as MICROSOFT INTERNET EXPLORER or NETSCAPE NAVIGATOR. After the browser has located the desired webpage, it requests and receives information from the webpage, typically in the form of an HTML document, and then displays the webpage content for the user. The user may then view other webpages at the same website or move to an entirely different website using the browser.

Browsers are able to locate specific websites because each website, resource and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other, e.g. 64.202.167.32. The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon, for example 2EDC:BA98:0332:0000:CF8A:000C:2154:7313.

However, IP addresses, even in a human readable notation, are difficult to remember and use by people. Uniform Resource Locators (URL) are much easier to remember and may be used to point to any website, directory or file on the Internet. A browser is able to access a website on the Internet through the use of a URL. The URL may include a Hypertext Transfer Protocol (HTTP) request combined with the website's Internet address, also known as the website's domain name. An example of a URL with an HTTP request and domain name is: http://godaddy.com. In this example, the “http” identifies the URL as an HTTP request and the “godaddy.com” is the domain name.

Individuals, companies, and other entities that provide content on the web generally want to use their name or one of their trademarks as part of their domain name. Thus, domain names are generally company trademarks, personal names or short phrases concatenated with a top level domain name (TLD) extension (e.g. .com, .net, .org, .us, .biz, etc.). Domain names created in this fashion are much easier to remember and use than their corresponding IP addresses. The Internet Corporation for Assigned Names and Numbers (ICANN) approves all TLDs and delegates the responsibility to a particular organization (hereinafter registry) for maintaining an authoritative source for the registered domain names within a TLD and their corresponding IP addresses. For certain TLDs, e.g. .biz, .info, .name, and now org, the registry is also the authoritative source for contact information related to the domain name and is referred to as a “thick” registry. For other TLDs, e.g. .com, .net, only the domain name and name server information is stored within the registry, and a registrar is the authoritative source for the contact information related to the domain name. Such registry is referred to as a “thin” registry. All domain names are organized through a central domain name Shared Registration System (SRS) based on their TLD. There is only one organization, or registry, for each of the ICANN approved TLDs.

The process for registering a domain name with a particular registry allows a Customer to use an ICANN-accredited registrar. For example if a Customer, John Doe, wishes to register the domain name “JohnDoe.com”, John Doe may initially verify whether the desired domain name is or is not available by contacting a registrar. The Customer may make this contact using the registrar's webpage and typing the desired domain name into a field on the registrar's webpage created for this purpose. Upon receiving the request from the Customer, the registrar may ascertain whether “JohnDoe.com” has already been registered by checking the SRS database of the registry associated with the TLD of the domain name. The results of the search may then be displayed on the webpage to thereby notify the Customer of the availability of the domain name. If the domain name is available, the Customer may proceed with the registration process. Otherwise, the Customer may keep selecting alternative domain names until an available domain name is found.

The domain names are typically registered for a period of one to ten years. If the registrant does not renew the domain name, it will expire. Shortly after the domain name goes past its expiration date the domain name will be deactivated. All domain services including the web page and email will no longer work. For approximately 40 days the domain name will be in a “grace period”. During this time the domain name will not be active and may be renewed without paying any additional fees. At the end of the grace period the domain will enter a 30-day redemption period. WHOIS information (name, address, telephone numbers, etc.) will be deleted. The domain may be renewed by its original owner for a fee. Five days after the end of the redemption period the domain name will be deleted from the registry and will be made available for anyone to register.

The Internet consists of millions of computers that store electronic files that may be accessed via a web browser. The web holds an enormous amount of data. Webpages are created to present all kinds of information, from commercial catalogs and advertisements, to scientific literature, to governmental regulations, etc. Presently, the web consists of billions of webpages. Without the appropriate tools, finding specific information stored somewhere in the billions of webpages is like trying to find a needle in a haystack.

A search engine is a tool that facilitates locating desired information on a computer network such as the Internet. A user usually accesses a website that hosts a search engine and submits one or more search queries related to the information sought. Generally, a search engine is a computer program that, when queried for information, retrieves either related information or pointers to the location of related information, or both, by evaluating its database. In the Internet context, when a user submits a query, the search engine usually responds with a list of URLs pointing to information resources, typically webpages hosted on other websites that are derived from matching entries in the search engine's database.

Many Internet users employ search engines to find a variety of information on the Internet. However, many users do not know how to register a domain name. Often they even do not know where to begin. Therefore, new systems and methods are needed that allow Internet users to register domain names utilizing their familiarity with search engines.

### SUMMARY OF THE INVENTION

The limitations cited above and others are substantially overcome through the systems and methods disclosed herein. The systems and methods of the present invention allow for a search engine to suggest to a user one or more domain names related to a search query provided by the user to the search engine.

A user may employ a search engine to search information on a computer network, such as the Internet. The user, typically, will provide a search query on a search engine website. The search engine then passes the search query to a domain name module.

The domain name module determines domain names that may be suggested to the user. The domain name module returns suggested domain names to the search engine. The search engine displays the search results and suggested domain names to the user via the search engine website.

The systems and methods of the present invention will help users familiar with search engines to obtain domain names. The invention may be used as a marketing feature for the search engines, domain name registrars, or domain name resellers.

The above features and advantages of the present invention will be better understood from the following detailed description taken in conjunction with the accompanying drawings.

### BRIEF DESCRIPTION OF THE DRAWINGS

FIG. 1 is a block diagram illustrating an embodiment of the system of the present invention.

FIG. 2 is a block diagram illustrating another embodiment of the system of the present invention.

FIG. 3 is a block diagram illustrating a sample embodiment of the domain name module illustrated in FIGS. 1 and 2.

FIG. 4 illustrates a mock-up webpage implementing an embodiment of the present invention. The webpage is maintained by a domain name registrar.

FIG. 5 illustrates a mock-up webpage implementing an embodiment of the present invention. The webpage is maintained by a search engine company.

FIGS. 6-9 are flowcharts illustrating various embodiments of a method of the present invention.

FIG. 10 is a flowchart illustrating a sample embodiment of a method of the present invention.

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

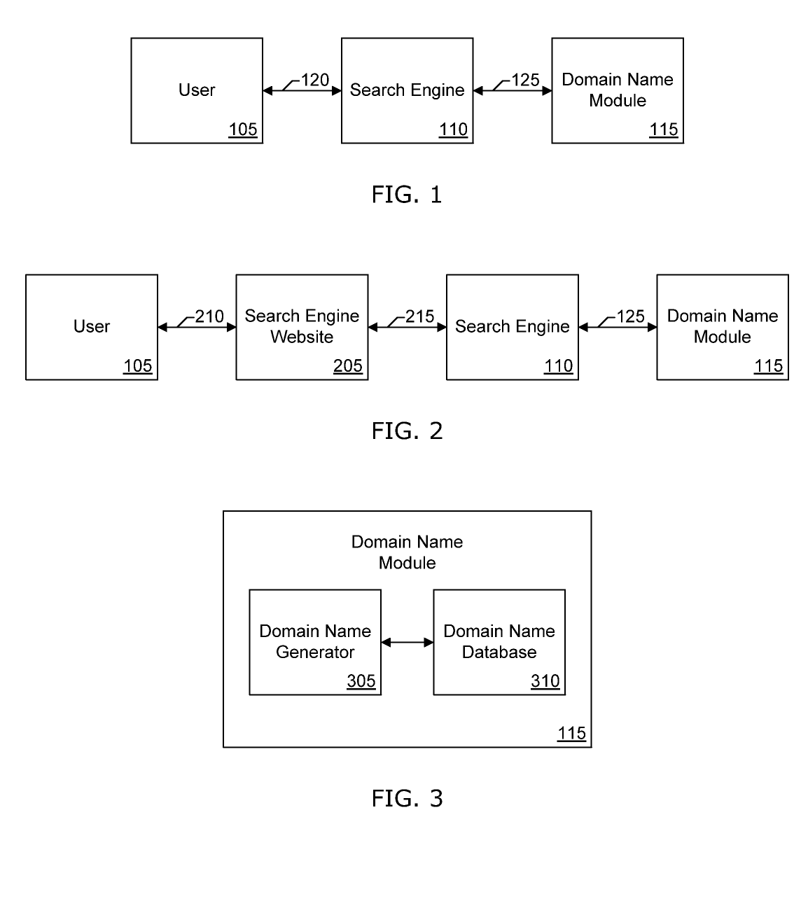

Referring to FIG. 1, a user 105 may provide a search query to a search engine 110 via a communication link 120. The search engine 110 may forward the search query to a domain name module 115 via a communication link 125. The user 105 (also called requestor) may be a natural person or a technological means having an ability to provide the search query to the search engine 110. The search engine 110 is a technological means for searching data on a computer network. Typically, the search engine 110 comprises a database that stores records on search terms and locations of the associated documents on the computer network, where such terms are present.

The domain name module 115 is a technological means for generating (producing) one or more domain names based on the search query provided by the user 105. While generating the domain names, the domain name module 115 may concatenate search terms in the search query, provide alternative spellings of the search terms, provide alternative terms that are similar in meaning to the search terms, change between single and plural forms of the search terms, append prefixes and suffixes to the search terms, add additional characters to the search terms (e.g. dash), rearrange the search terms in the query, add domain name suffixes to the terms (e.g. .com, .net, .org, .us, .co.uk, .go.com), etc. The domain name suffixes may be top level domain name (TLD) extensions (e.g. .com, .net, .org, .us, etc.) or subdomains of any level (e.g. .co.uk, .go.com, subdomain2.subdomain1.com, etc.).

Referring to FIG. 2, a search engine 110 may be exposed to a user 105 via a search engine website 205. The user 105 may provide a search query to the search engine website 205 via a communication link 210. The communication link 210 may be a graphical user interface (GUI) of the search engine website 205, having one or more input fields, where the user 105 may provide the search query using input devices, such as a computer keyboard and mouse. The search engine website 205 may deliver the search query to the search engine 110 via a communication link 215. The communication link 215 may be a programming interface collecting data from the fields on the search engine website 205 and delivering such data to the search engine 110.

Referring to FIG. 3, the domain name module 115 may comprise a domain name generator 305 and a domain name database 310. The domain name generator 305 may generate the domain names based on the search terms in the search query. The domain name database 310 may store active (previously registered and currently not expired) domain names. The active domain names are not available for registration, thus when the domain name generator 305 generates the domain names it may filter out the active domain names.

Alternatively or additionally the domain name database 310 may store expired (previously registered and currently expired) domain names. Thus, the domain name generator 305 may find in the domain name database 310 the expired domain names that contain one or more search terms from the search query. Also parts, variations, synonyms, or alternatives of the search terms may be used to find the expired domain names in the domain name database 310. The expired domain names may be more appealing for a new registration than other domain names.

Alternatively or additionally the domain name database 310 may store registered domain names available for sale. Thus, the domain name generator 305 may find in the domain name database 310 the registered domain names available for sale that contain one or more search terms from the search query. Also parts, variations, synonyms, or alternatives of the search terms may be used to find the registered domain names available for sale in the domain name database 310. The registered domain names available for sale may be more appealing to the user than other domain names.

Further the domain name database 310 may store domain names which are in “on hold” status by the registry (typically during the grace period or redemption period).

If the domain name is already registered and is not available for sale, the user may backorder it (i.e. buy it when it becomes available) or make an offer to purchase it from the current owner.

The communication links 120 and 125 may be part of a computer network. The search engine 110 and the domain name module 115 may be located on the same physical server.

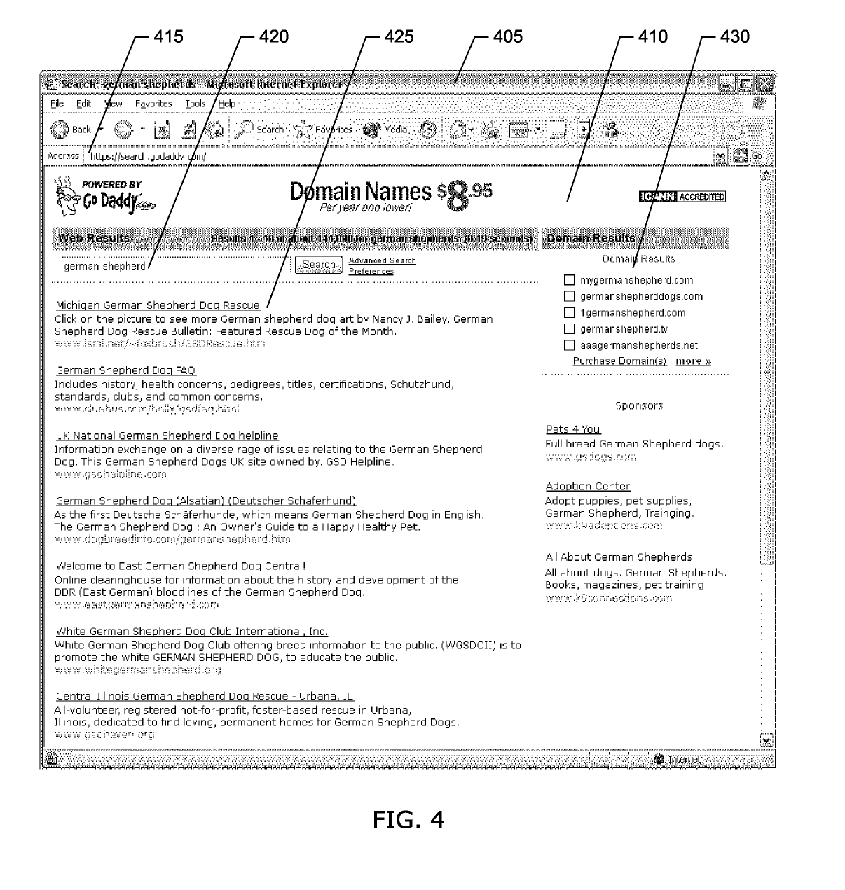

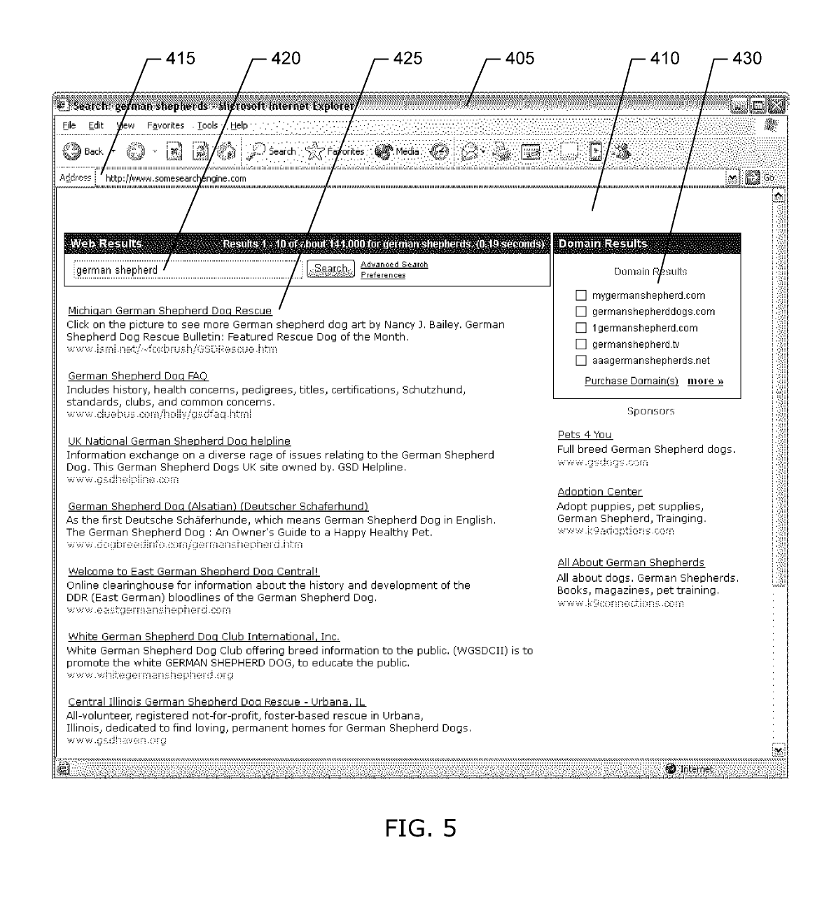

FIGS. 4 and 5 demonstrate mock-up webpages implementing sample embodiments of the present invention. A user may use a web browser 405 to view a webpage 410. The webpage 410 may be located on a computer network, such as the Internet, at a network location 415 (also known as a URL). The user may provide a search query 420 to the webpage 410. A search engine may return search results 425 and suggested domain names 430 to the user and display them on the webpage 410.

A search engine and/or a search engine website may be maintained by any party. FIG. 4 shows a webpage of the search engine website that may be maintained by a domain name registrar, such as GO DADDY. FIG. 5 shows a webpage of the search engine website that may be maintained by a specialized search engine company.

The suggested domain names 430 may appear as an advertisement on the search engine webpage. The suggested domain names 430 may appear as links to the websites where the domain names may be obtained. Such websites may include domain name registrars, domain names sellers, websites that sell domain names through a secondary market (e.g. domain name auction sites), etc. Additionally, the suggested domain names 430 may be accompanied by checkboxes. The user may select one or more checkboxes and then register/buy selected domain names as a group or obtain additional information on those names (e.g. prices or availability).

The domain name may or may not be necessarily available for registration or sale. Availability of the domain name may be further determined if the user expresses an interest in the domain name and clicks on the provided link or selects a checkbox. The user may backorder active domain name or make an offer to purchase it. Further the search engine may provide the user with the option to select the types of domain names that the user may be interested (e.g. show only available domain names).

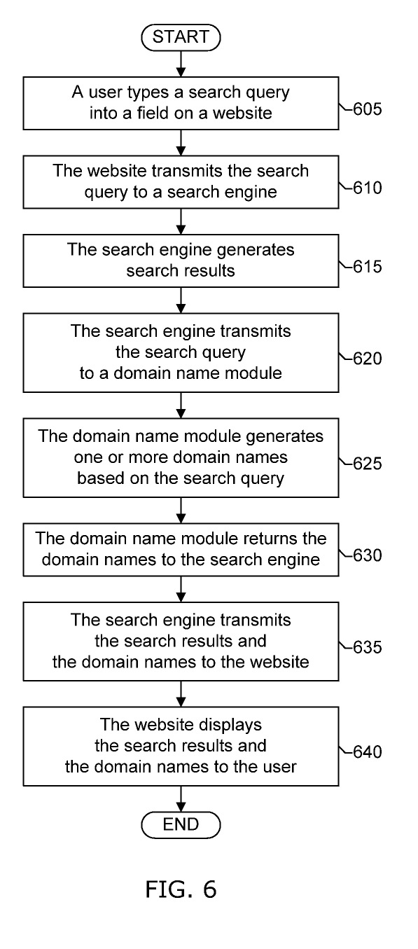

Referring to FIG. 6, a user may type a search query into a field on a website (Step 605). The website may transmit the search query to a search engine (Step 610). The search engine generates search results (Step 615). The search engine may transmit the search query to a domain name module (Step 620). The domain name module may generate one or more domain names based on the search query (Step 625). The domain name module may return the domain names to the search engine (Step 630). The search engine may transmit the search results and the domain names to the website (Step 635). The website may display the search results and the domain names to the user (Step 640).

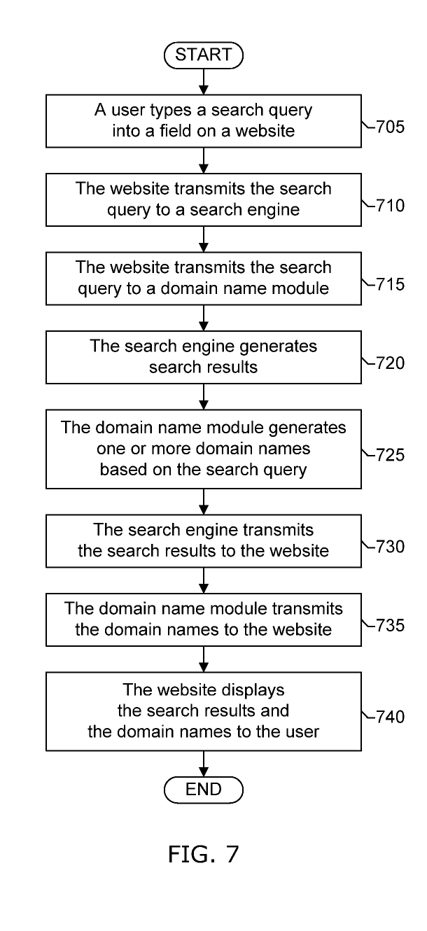

In another embodiment of the method, shown in FIG. 7, a user may type a search query into a field on a website (Step 705). The website may transmit the search query to a search engine (Step 710). The website may transmit the search query to a domain name module (Step 715). The search engine may generate search results (Step 720). The domain name module may generate one or more domain names based on the search query (Step 725). The search engine may transmit the search results to the website (Step 730). The domain name module may transmit the domain names to the website (Step 735). The website may display the search results and the domain names to the user (Step 740).

The website in the methods shown in FIGS. 6 and 7 may be maintained by a search engine company, a domain name registrar, a domain name reseller, or any other entity.

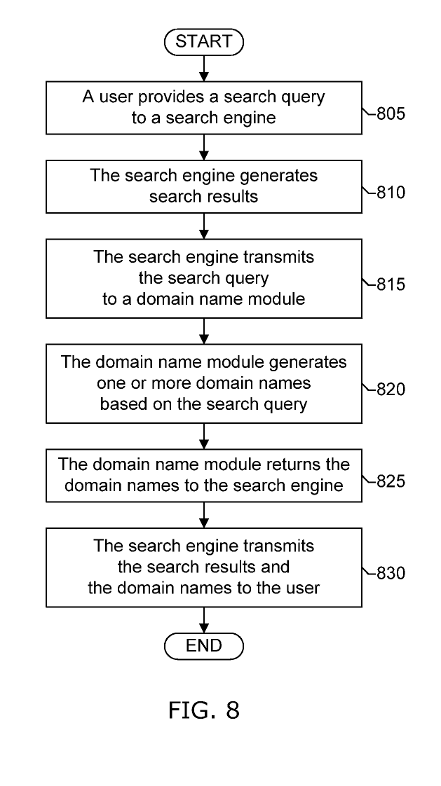

An alternative embodiment of the method is illustrated in FIG. 8. A user may provide a search query to a search engine (Step 805). The search engine may generate search results (Step 810). The search engine may transmit the search query to a domain name module (Step 815). The domain name module may generate one or more domain names based on the search query (Step 820). The domain name module may return the domain names to the search engine (Step 825). The search engine may transmit the search results and the domain names to the user (Step 830).

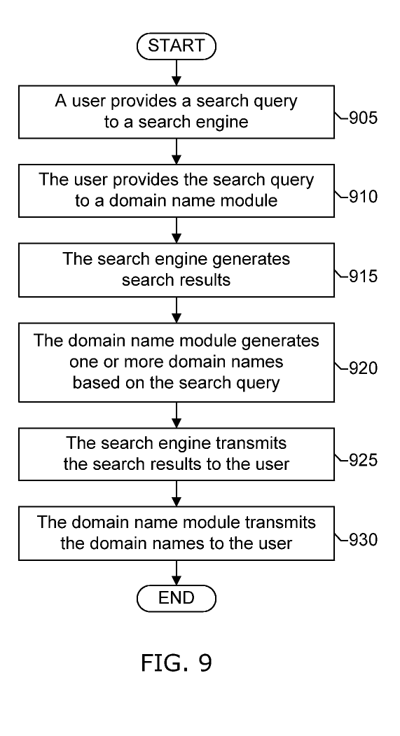

In yet another embodiment of the method, shown in FIG. 9, a user may provide a search query to a search engine (Step 905). The user may provide the search query to a domain name module (Step 910). The search engine may generate search results (Step 915). The domain name module may generate one or more domain names based on the search query (Step 920). The search engine may transmit the search results to the user (Step 925). The domain name module may transmit the domain names to the user (Step 930).

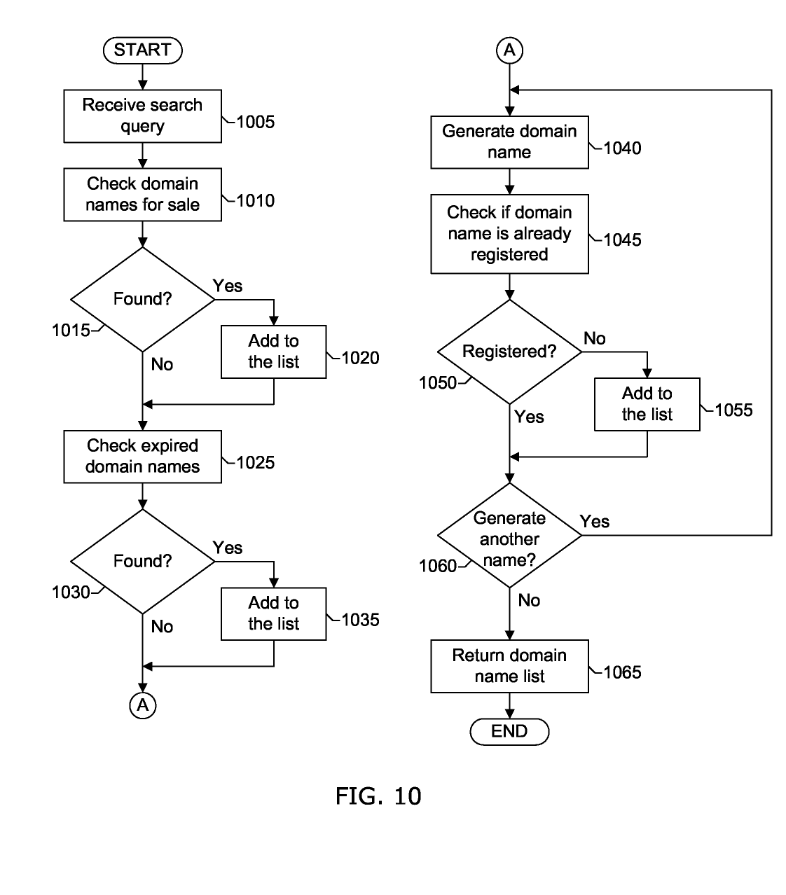

The following example demonstrates how the domain names may be generated. A user may type “German shepherds” into a field on a website and click the “Search” button on the website. “German shepherds” is a search query comprising of two search terms. A search engine may receive the search query “German shepherds” and forward it to a domain name module. Referring to FIG. 10, the domain name module may receive the search query (Step 1005). The domain name module may check if domain names with terms “German” and/or “shepherd” (or their parts, variations, synonyms, or alternatives) are available for sale (Step 1010). If the domain names available for sale with the search terms are found (Step 1015), they may be added to a list of domain names that will be later on shown to the user (Step 1020). Then, the domain name module may check if expired domain names with terms “German” and/or “shepherd” (or their parts, variations, synonyms, or alternatives) are available for registration (Step 1025). If the expired domain names available for registration with the search terms are found (Step 1030), they may be added to the list (Step 1035).

Further, the domain name module may generate a domain name based on the search terms (e.g. german-shepherds.com, germanshepherd.us, 123germanshepherd.net, shepherdsgerman.org, etc.) (Step 1040). The domain name module may check if the domain name is already registered (Step 1045). If the domain name is not registered (Step 1050), it may be added to the list (Step 1055). If more domain names are desired (Step 1060), the process may be repeated starting at Step 1040. Finally, the domain name module may return the domain list to the search engine. The search engine may in turn form a webpage with search results and the domain names and display it to the user.

Some steps described above and illustrated in FIGS. 6-10 may be performed simultaneously or in different order. For example generating search results and generating the domain names may be performed simultaneously. Also the various steps described above may be performed by various machines and apparatuses; and not necessarily by those described or mentioned above.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The elements described in this specification in plural form may also be construed as singular, unless specifically stated otherwise. The elements described in this specification in singular form may also be construed as plural, unless specifically stated otherwise.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

1. A system for providing domain name suggestions in conjunction with searching a computer network comprising:
a) a search engine, wherein said search engine is a technological means for searching information on a computer network in response to a search query, and
b) a domain name module, wherein said domain name module is a technological means for producing one or more domain names in response to said search query.

2. The system of claim 1, further comprising:
c) a requester, wherein said requester is providing said search query to said search engine.

3. The system of claim 1, further comprising:
c) a search engine website, wherein said search engine website has ability to accept said search query.

4. The system of claim 1, wherein said domain name module comprises a domain name generator.

5. The system of claim 1, wherein said domain name module comprises a domain name database.

6. The system of claim 5, wherein said domain name database stores active domain names.

7. The system of claim 5, wherein said domain name database stores expired domain names.

8. The system of claim 5, wherein said domain name database stores domain names in the “on hold” status.

9. The system of claim 5, wherein said domain name database stores domain names available for sale.

10. A method for providing domain name suggestions in conjunction with searching a computer network, comprising the steps of:
a) obtaining a search query from a requester,
b) generating search results based on said search query,
c) generating a domain name based on said search query, and
d) providing said search results and said domain name to said requester.

11. The method of claim 10, further comprising a step of:
e) registering said domain name to said requester.

12. The method of claim 10, further comprising a step of:
e) selling said domain name to said requester.

13. The method of claim 10, further comprising a step of:
e) backordering said domain name to said requester.

14. The method of claim 10, wherein said domain name is available for registration.

15. The method of claim 10, wherein said domain name is available for sale.

16. The method of claim 10, wherein said domain name is selected from active domain names.

17. The method of claim 10, wherein said domain name is selected from expired domain names.

18. The method of claim 10, wherein said domain name is selected from domain names in the “on hold” status.

19. The method of claim 10, wherein said domain name is selected from domain names available for sale.

20. The method of claim 10, wherein said search query is obtained via a website.

21. A method for providing a domain name available for registration to a requester entering a search query into a website, comprising the steps of:
a) a website receiving a search query from a requester,
b) a search engine generating a list of one or more webpages related to said search query,
c) a domain name module generating a list of one or more domain names related to said search query, and
d) said website displaying said list of websites and said list of domain names to said requester.

22. The method of claim 21, wherein said requester is given an option to register at least one of said domain names on said list of domain names.

23. The method of claim 21, wherein said list of said webpages and said list of said domain names are viewable on a single webpage.
